(19) United States
(12) Patent Application Publication
(10) Pub. No.: US 2003/0209968 A1
(43) Pub. Date: Nov. 13, 2003

(54) Color picture tube and deflection system for color picture tubes having improved convergence

(75) Inventor: Andreas Ehrhardt, Plochingen (DE)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(73) Assignee: Matsushita Display Devices (Germany) GmbH

(21) Appl. No.: 10/409,020

(22) Filed: Apr. 8, 2003

(30) Foreign Application Priority Data
Apr. 19, 2002 (EP) 02008410.9

(51) Int. Cl. H01J 29/70

(52) U.S. Cl. 313/440

(57) ABSTRACT

The invention therefore refers to a color picture tube and to a deflection system for a color picture tube having a rectangular luminescent screen and an inline electron beam generation system. An inline electron beam generation system generates a plurality of electron beams substantially extending in a common plane, said electron beams being directed towards the luminescent screen. Correction magnets are arranged on the color picture tube and in the deflection system of a color picture tube, respectively, to correct a vertical green bending in the corners of the luminescent screen. The correction magnets are arranged substantially in a plane perpendicularly to the direction of the electron beams. Within this plane, the correction magnets are arranged at an angle to the common plane in which the electron beams extend which is between 20° and 70°. The present invention therefore enables a color picture tube, in which a conventional vertical green bending can be corrected without great additional effect and which can be manufactured at a low price despite improved imaging properties.

### BACKGROUND OF THE INVENTION

1. Field of the Invention

The invention generally refers to a color picture tube and particularly to color picture tubes which have an improved deflection unit for smaller aberrations.

2. Description of the Related Art

The deflection of electron beams in a color picture tube is implemented by magnetic fields which are generated by horizontal and vertical deflection coils of a deflection unit. The deflection unit, which is mounted on a color picture tube, substantially consists of two coil pairs and a ferrite core. A first coil pair generates a magnetic field which deflects the electron beams generated by electron beam generation systems in the horizontal direction (X-direction), whereas the other coil pair effects a vertical deflection (Y-direction). The ferrite core encompasses both coil pairs and serves for returning the magnetic flux.

Modern color picture tubes have electron beam generation systems in a so-called inline arrangement, in which the electron beam generation systems for the different color components are arranged in juxtaposition in one plane. The axes of the electron beams generated in systems of this type extend co-planarly and converge on the screen.

The three electron beams must each converge in a point in front of the shadow mask so that they each hit the luminous spots associated to the electron beams. Generally, it is not the same deflection force that acts on the central electron beam as acts on the two lateral electron beams due to the inhomogeneous fields. The variable deflection of the individual electron beams serves amongst others for reducing convergence errors, which, however, cannot always be eliminated completely so that the three electron beams in these cases do not converge in a point in front of the shadow mask.

It is particularly difficult to correct in the marginal portion of the screen an outwardly directed “bending” of the vertical lines of the green color component (central electron beam) relative to the red and blue color component (lateral electron beams). This convergence error is schematically shown for a rectangular luminescent screen in FIG. 1. While the point of impact of the red and blue color components (r, b) could each be completely corrected, an error of the green color component (g) in the marginal portions of the luminescent screen remains.

It is the object of the invention to provide a color picture tube and a deflection system with an improved color convergence.

### SUMMARY OF THE INVENTION

According to a first aspect, the present invention provides a color picture tube having a rectangular luminescent screen and an inline electron beam generation system for generating a plurality of electron beams extending substantially in a common plane. The electron beams are directed towards the luminescent screen. Correction magnets are mounted on the outside of the color picture tube, which are substantially arranged on a plane perpendicular to the direction of the electron beams and in this plane at an angle between 20° and 70° towards the common plane in which the electron beams extend.

According to another aspect, the present invention provides a deflection unit for a color picture tube having a rectangular luminescent screen and an inline electron beam generation system for generating a plurality of electron beams substantially extending in a common plane. The electron beams being directed towards the luminescent screen of the color picture tube. The deflection unit comprises correction magnets which are arranged in the deflection system substantially in a plane perpendicularly to the direction of the electron beams and in this plane at an angle between 20° and 70° to the common plane in which the electron beams extend.

According to the invention, an improvement of the convergence in the corners of the screen is achieved by a special arrangement of additional correction magnets. For this purpose, additional correction magnets are arranged on the outside of the color picture tube. These correction magnets are located substantially in a plane perpendicular to the direction of the electron beams and are arranged in this plane in a manner that they are located at an angle between 20° and 70° to the inline plane. In the case of such an arrangement of correction magnets, each of the correction magnets effects a local magnetic field, which, because of its position, its dimensioning and the distances of the three beams with respect to each other existing in this area, leads to a differently strongly deflection of the individual color components. In this manner, the color components can be affected independently of each other and the green bending in the corners of the screen can substantially be improved.

According to a further aspect of the invention, the correction magnets are arranged in the deflection system of a color picture tube. Thereby a simple structure and a simple manufacture of the color picture tube according to the invention may be achieved.

According to an advantageous embodiment of the invention, the correction magnets are each arranged symmetrically at an angle of 60° to the inline plane. In the case of such a positioning of the correction magnets can an especially efficient improvement of the convergence correction be achieved in a simple manner.

Preferred embodiments of the invention are defined in the dependent claims.

### BRIEF DESCRIPTION OF THE DRAWINGS

The accompanying drawings are incorporated into and form a part of this specification for the purpose of explaining the principles of the invention. The drawings are not to be construed as limiting the invention to only the illustrated and described examples of how the invention can be made and used. Further features and advantages could become apparent from the following and more particular description of the invention, as illustrated in the accompanying drawings, wherein:

FIG. 1 schematically shows the vertical green bending on the luminescent screen of a color picture tube;

FIG. 2 schematically shows the structure of a color picture tube;

FIG. 3 shows a schematic view of a deflection system according to the invention for a color picture tube with the correction magnets being arranged at certain angular positions;

FIG. 4 shows the structure of the deflection system according to the invention of FIG. 3 in a side view;

FIG. 5 shows in a schematic view the differently strong deflection of the electron beams of an inline electron beam generation system effected by the correction magnets;

FIG. 6 shows a schematic view of a luminescent screen of a color picture tube according to the invention having a correction effected by the additional magnets; and

FIG. 7 shows a schematic view of a luminescent screen of a color picture tube according to the invention with an optimum correction of convergence.

### DETAILED DESCRIPTION OF THE INVENTION

The illustrative embodiments of the present invention will be described with reference to the Figure drawings.

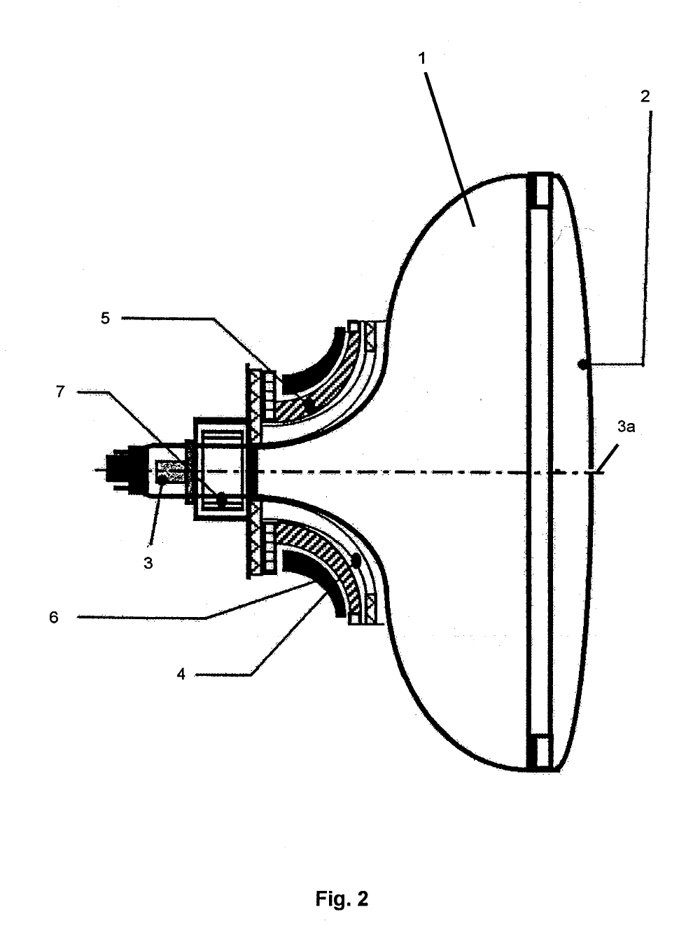

FIG. 2 shows a sectional view of a color picture electron beam tube 1. The color picture tube is provided with a luminescent layer on the inner side of the screen surface 2 and comprises an electron beam generation system 3 arranged in the neck of the color picture tube. The electron beam generation system is an inline electron beam generation system. An inline electron beam generation system is an electron beam generation system, which preferably generates three electron beams extending in one common plane 3a, said electron beams being directed towards the luminescent screen 2. A deflection system is mounted on the outside of the glass body of the color picture tube. The deflection system comprises a horizontal deflection coil pair 4, a vertical deflection coil pair 5 and a ferrite core 6 encompassing both coils. Such a deflection system having a substantially funnel-like structure effects a deflection of the electron beams generated by the electron beam generation system 3 in the X-direction and in the Y-direction. The deflection unit additionally comprises correction magnets and possibly magnetically soft field formers so that a self-converging image without NS raster distortion is generated.

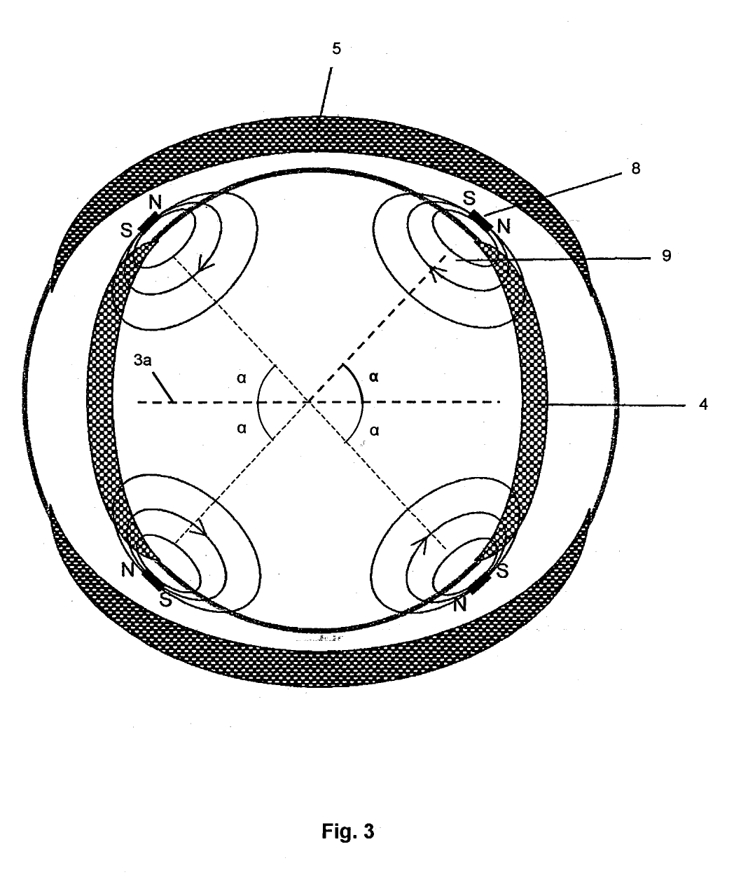

FIG. 3 shows a schematic view of the deflection system according to the invention in the direction of the Z-axis of the color picture tube. The vertical deflection coils are designated by reference numeral 5. The horizontal deflection coils are designated by reference numeral 4. Additionally, this view shows four rotationally-symmetrically arranged correction magnets 8. Preferably, all four correction magnets are arranged at an angle α of approx. 60° to the inline plane 3a. Depending on the structure and shape of the color picture tube, the additional correction magnets may be positioned within an angular range of 20° to 70° for the angle α, preferably within an angular range between 50° and 60°.

The positioning of the correction magnets 8 according to the invention effects that the three electron beams extending horizontally next to each other are differently strongly deflected by the magnetic field 9 generated by one correction magnet 8 each. A suitable shift of the electron beams with respect to each other can be adjusted for the convergence correction via the polarity and dimensioning of the magnetic field.

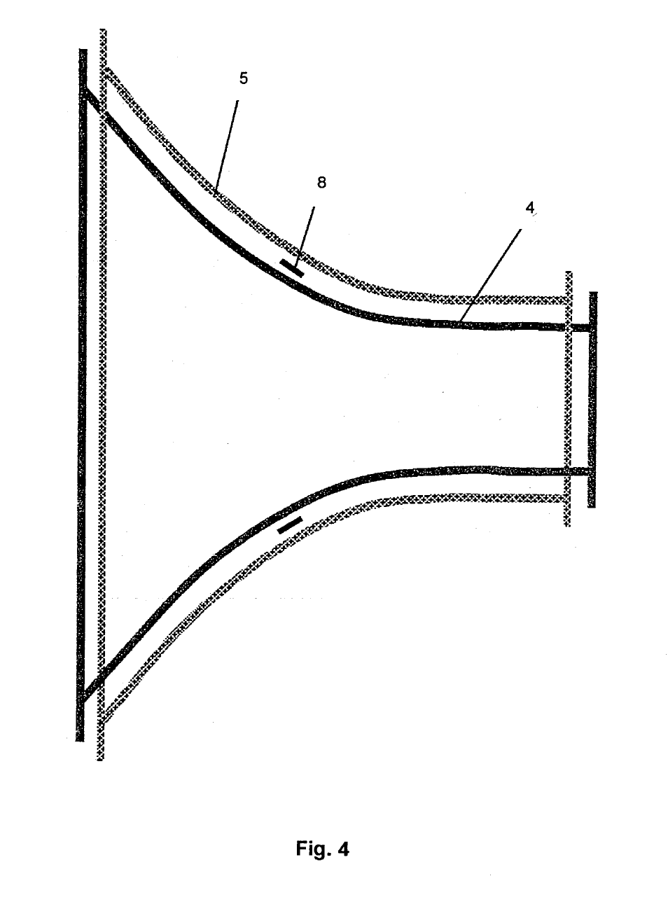

The correction magnets 8 are preferably mounted in the Z-direction of the color picture tube in a central plane with respect to the deflection system. An arrangement of this type is shown in FIG. 4. The correction magnets 8 are preferably provided on the horizontal coils 4 of the deflection system that consists of horizontal coils 4 and vertical coils 5. By shifting the plane of the correction magnets 8 in the Z-direction of the color picture tube, the influence of the magnetic fields 9 on the electron beams can be varied.

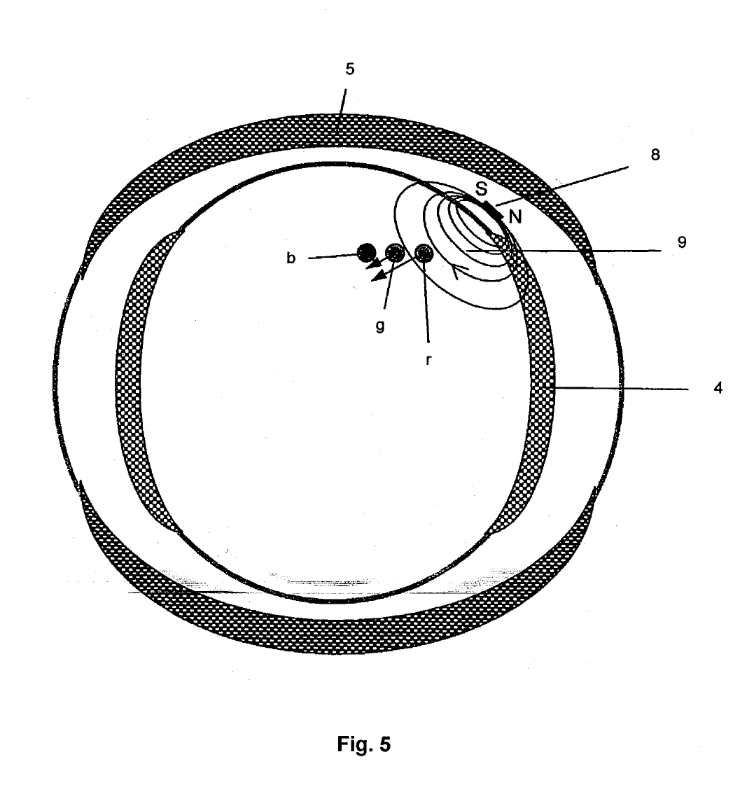

FIG. 5 shows a further schematic view of the deflection system of FIG. 3. To elucidate the variable influence of the electron beams of an inline electron beam generation system, one correction magnet 8 only is shown. The electron beams b, g and r extending through the field lines 9 of the correction magnet are differently strongly influenced by the correction magnet. In FIG. 5 it can be seen that the correction magnets 8 effect on the one side of the screen substantially a shift of the red and green color component g and r relative to the blue color component b. The direction and strength of the shift is indicated in FIG. 5 by the arrows starting at the electron beams g and r. On the opposite side of the screen a corresponding shift of the blue and green color components relative to the red color component in the direction towards the center of the screen (not shown) takes place.

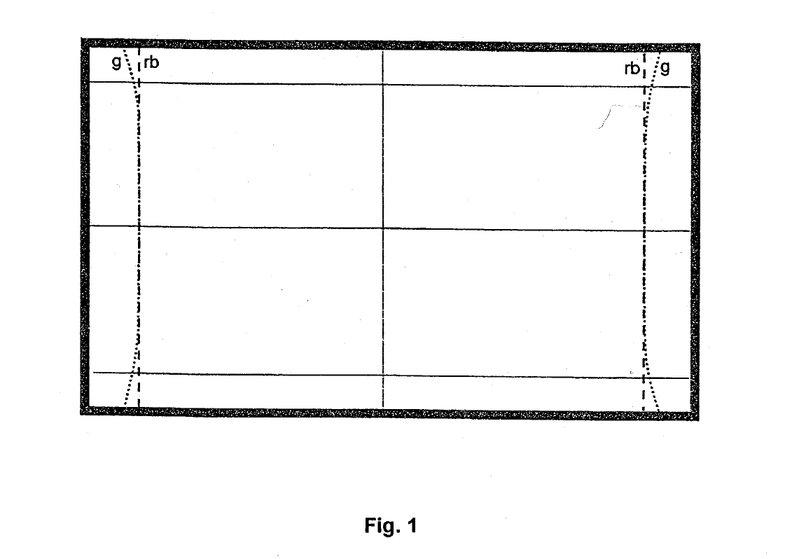

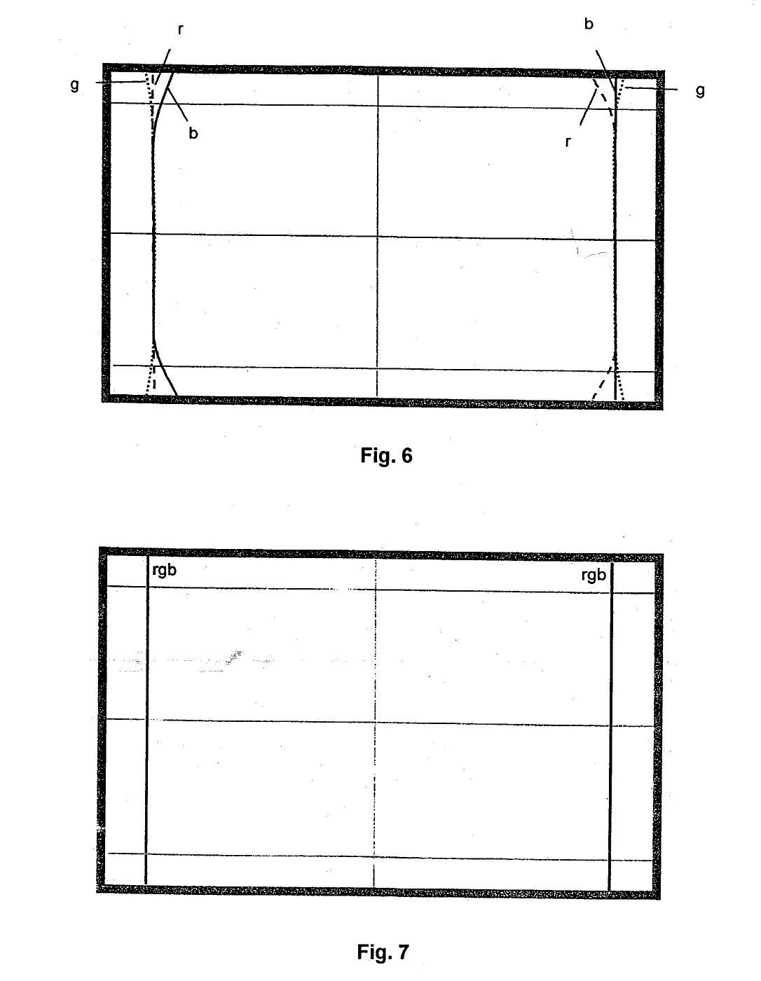

By the aid of the correction magnet 8, the individual electron beams r, b, g can be shifted with respect to each other in a manner that in the corner regions the vertical green bending shown in FIG. 1 is “transformed” into a vertical bending of one of the two lateral electron beams. A schematic view of a shift of the color components with respect to each other effected by the correction magnets is shown in FIG. 6.

A convergence error, as it is shown in FIG. 6, can easily be eliminated by conventional correction methods. The winding distribution of the horizontal or vertical coils may for instance be varied and/or additional geometry magnets may be arranged in different planes of the deflection system so that this “transformed” convergence error can also be corrected.

FIG. 7 shows a correspondingly corrected color screen with a correction of the original green bending (cf. FIG. 1) according to the invention. The degree of the change of the green bending can greatly be influenced through the position, size and power of the correction magnets 8.

The invention therefore refers to a color picture tube and to a deflection system for a color picture tube having a rectangular luminescent screen and an inline electron beam generation system. An inline electron beam generation system generates a plurality of electron beams extending substantially in a common plane, said electron beams being directed towards the luminescent screen. To correct a vertical green bending in the corners of the luminescent screen, correction magnets are arranged on the color picture tube and in the deflection system of a color picture tube, respectively. The correction magnets are arranged substantially in a plane perpendicularly to the direction of the electron beams. The correction magnets are arranged within this plane at an angle of between 20° and 70° towards the common plane on which the electron beams extend.

The present invention therefore enables a color picture tube, in which a conventional vertical green bending in the marginal portions of the screen can be corrected without great additional effort and which can be manufactured at low cost despite improved imaging properties.

While the invention has been described with respect to the physical embodiments constructed in accordance therewith, it will be apparent to those skilled in the art that various modifications, variations and improvements of the present invention may be made in light of the above teachings and within the purview of the independent claims without departing from the spirit and the intended scope of the invention. In addition, those areas in which it is believed that those of ordinary skill in the art are familiar, have not been described herein in order to not unnecessarily obscure the invention described herein. Accordingly, it is to be understood that the invention is not to be limited by the specific illustrative embodiments, but only by the scope of the dependent claims.

What is claimed is:

1. A color picture tube having a rectangular luminescent screen and an inline electron beam generation system for generating a plurality of electron beams extending substantially in a common plane, said electron beams being directed towards the luminescent screen, wherein correction magnets are mounted on the outside of the color picture tube, which are substantially arranged on a plane perpendicular to the direction of the electron beams and in this plane at an angle between 20° and 70° towards the common plane in which the electron beams extend.

2. A color picture tube as claimed in claim 1, wherein the correction magnets are arranged in the area of a deflection system mounted on the outside of the color picture tube for deflecting the electron beams.

3. A color picture tube as claimed in claim 2, wherein the deflection system comprises a horizontal coil and a vertical coil and the correction magnets are mounted on the horizontal coil.

4. A color picture tube as claimed in one of claims 1, wherein the correction magnets are arranged each at an angle between 50° and 65° with respect to the common plane in which the electron beams extend.

5. A color picture tube as claimed in one of claims 1, wherein the correction magnets are arranged each at an angle of approximately 60° to the common plane in which the electron beams extend.

6. A deflection unit for a color picture tube having a rectangular luminescent screen and an inline electron beam generation system for generating a plurality of electron beams substantially extending in a common plane, said electron beams being directed towards the luminescent screen of the color picture tube, wherein said deflection unit comprising correction magnets which are arranged in the deflection system substantially in a plane perpendicularly to the direction of the electron beams and in this plane at an angle between 20° and 70° to the common plane in which the electron beams extend.

7. A deflection system as claimed in claim 6, wherein the correction magnets are each arranged at an angle between 50° and 65° to the common plane in which the electron beams extend.

8. A deflection system as claimed in claim 6, wherein the correction magnets are each arranged at an angle of approximately 60° to the common plane in which the electron beams extend.
